(19) United States
(12) Patent Application Publication
(10) Pub. No.: US 2025/0243737 A1
(43) Pub. Date: Jul. 31, 2025

(54) OPTIMIZATION OF PUMP RATES FOR HYDRAULIC FRACTURING

(71) Applicant: Halliburton Energy Services, Inc., Houston, TX (US)

(72) Inventors: Zhijie SUN, Houston, TX (US); Tirumani Swaminathan, Houston, TX (US); Behrouz Ebrahimi, Katy, TX (US)

(73) Assignee: Halliburton Energy Services, Inc., Houston, TX (US)

(21) Appl. No.: 18/422,882

(22) Filed: Jan. 25, 2024

(51) Int. Cl. E21B 43/26; G05D 7/06

(52) U.S. Cl. CPC E21B 43/2607; G05D 7/0623

(57) ABSTRACT

Aspects of the disclosed technology provide solutions for optimizing pumps in hydraulic fracturing and, in particular, for determining optimal pump rate setpoints for a plurality of fracturing pumps. A process of the disclosed technology can include steps for coupling a plurality of fracking pumps to a respective controller and coupling a manifold to each of the fracking pumps. The process can further include steps for coupling a control system to each of the respective controllers, wherein the control system is configured to perform operations for receiving a total pump rate for the manifold and determining a plurality of pump rate setpoints for each of the plurality of fracking pumps and transmitting the plurality of pump rate setpoints to each of the respective controllers. Systems and machine-readable media are also provided.

### BACKGROUND

### 1. Technical Field

The present disclosure generally relates to solutions for optimizing pumps in hydraulic fracturing and in particular, for determining optimal pump rate setpoints for a plurality of fracturing pumps.

### 2. Introduction

Hydraulic fracking systems are often diesel powered, utilizing several different diesel engines to apply power to the hydraulic pumps as well as several types of auxiliary systems that assist the hydraulic pumps to execute the fracking. Such diesel-powered hydraulic fracking systems require a diesel engine and a transmission to be connected to a hydraulic pump to drive the hydraulic pump. However, typically several hydraulic pumps are required at a single fracking site to prepare the well for the later extraction of the fluid, such as hydrocarbons, from the existing well. Thus, each of the several hydraulic pumps positioned at a single fracking site require a single diesel engine and single transmission to adequately drive the corresponding hydraulic pump requiring several diesel engines and transmissions to also be positioned at the single fracking site in addition to the several hydraulic pumps.

### BRIEF DESCRIPTION OF THE DRAWINGS

Certain features of the subject technology are set forth in the appended claims. However, the accompanying drawings, which are included to provide further understanding, illustrate disclosed aspects and together with the description serve to explain the principles of the subject technology. In the drawings:

FIG. 1 illustrates an example environment of a hydraulic fracturing spread comprising a plurality of pumps, according to some aspects of the disclosed technology.

FIG. 2 illustrates an example workflow for optimizing pump rate setpoints, according to some aspects of the disclosed technology.

FIG. 3 illustrates another example workflow for optimizing pump rate setpoints, according to some aspects of the disclosed technology.

FIG. 4 illustrates an example process for optimizing pump rate setpoints, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring certain concepts.

Hydraulic fracturing pumps (also fracking pumps, pumps) can be used in fracking operations to pressurize and pump fracturing/fracking fluid (e.g., a slurry comprising water, sand, and chemicals) into a wellbore at high-pressures to create fractures in the subsurface rock formations to allow for oil and gas extraction. The pump's engine may serve as a power source for the pump by providing power to pressurize and inject the fracturing fluid into the rock at high-pressures. Fracking pumps may operate continuously over extended periods of time without a break. As a result, fracking pumps may be vulnerable to wear and corrosion and associated maintenance costs (e.g., the fracturing fluid can contain sand and chemicals that can be abrasive and corrosive to the internal components of the pumps).

The pump rate setpoint may be a predetermined value indicating the desired or target flow rate (e.g., barrels per minute; those skilled in the art will appreciate different flow rate configurations) of the fracturing fluid into the wellbore. In some cases, the pump engine's revolutions per minute (RPM) and gear selection can directly influence the pump flow rate. For example, a particular gear may correlate to a range of RPM values and pump flow rates (e.g., gear one may have a pump flow rate of A to B barrels per minute, gear two may have a pump flow rate of C to D barrels per minute, etc.).

A fracking setup may consist of a plurality of pumps, where each pump outputs a flow rate to generate a combined total flow rate (e.g., a total flow rate in barrels per minute is the combination of pump flow rates in barrels per minute of each pump in the plurality of pumps).

In some aspects, fracking pumps may have specific RPM ranges where they operate most efficiently with the least amount of wear and tear. For example, operating a pump's engine outside a specific range, either too high or too low, may lead to inefficiencies and increased wear on the pumps (e.g., high RPMs may cause overheating and excessive wear on the pump's engine components; low RPMs may cause carbon buildup and inefficient fuel usage). Additionally, the gear selection of a fracking pump can affect the pump's operational speed and torque. The gear ratio of the engine can impact the revolutions the engine makes to turn the pump a specific number of times. In some cases, selecting a particular gear can affect the gear ratio and also the engine's RPM. By way of example, a lower gear ratio can cause the engine to turn faster (e.g., higher RPM) for each rotation of the pump, while a higher gear ratio can cause the engine to turn slower (e.g., lower RPM) for each pump rotation. As such, selecting the appropriate gear is important for fracking operations as an incorrect gear selection may lead to suboptimal pump performance, increased fuel consumption (e.g., higher fuel costs), and mechanical stress on the engine.

In summary, there may be multiple pump flow rates (e.g., barrels per minute) for one or more fracking pumps to achieve a desired total pump flow rate (e.g., the total barrels per minute from the combination of the pump flow rates for the plurality of pumps). Optimizing the pump flow rates (e.g., and corresponding gear selections and RPM ranges) can be of importance to minimize the potential wear and tear of each pump and associated costs that may be incurred.

Aspects of the disclosed technology address the foregoing needs by providing solutions for determining the optimal distribution of pump rate setpoints for a plurality of pumps to achieve a desired total pump rate while also minimizing cost or maximizing profit.

In some examples, the pump rate settings for the plurality of pumps may be determined by solving an optimization problem that can minimize cost or maximize profit. By way of example, given a desired or total pump rate (also pump flow rate, spread rate), an optimization problem may be solved to determine the pump rate setpoints to send to each pump.

In some aspects, solving the optimization problem may be equivalent to minimizing a cost function or total costs incurred by operating the plurality of pumps (e.g., the cost from the total wear and tear of the plurality of pumps). For example, given a pump flow rate in barrels per minute, each pump may have a fixed cost and associated variable cost (e.g., the faster the pump flow rate, the more costs are incurred).

In some cases, solving the optimization problem may utilize a lesser amount of computing resources, and consequently provide a faster computation time, if the following assumptions are made: each pump and corresponding cost function in the plurality of pumps is the same, and the optimization problem is solved either in ascending or descending order of the pump flow rates.

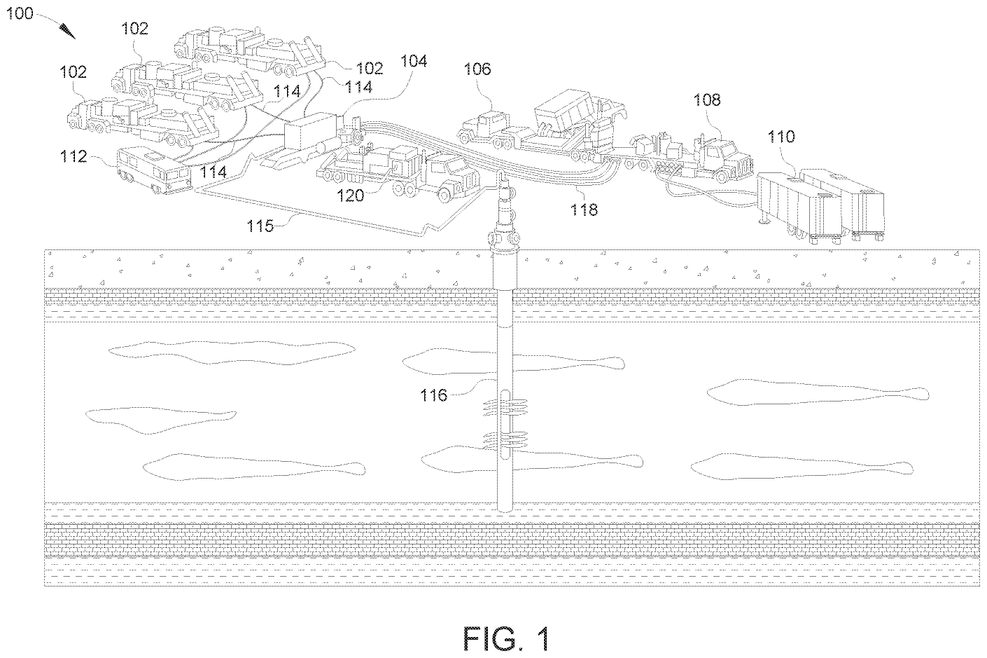

FIG. 1 illustrates an example environment 100 of a hydraulic fracturing spread comprising a plurality of pumps 102, according to some aspects of the disclosed technology. As discussed above, fracking fluid, or slurry, can comprise water, sand, and chemicals. In the example environment 100, fluid storage tanks 110 may include base fluids such as water and chemicals. The base fluids may then be mixed with proppant 106 (e.g., sand) via blender 108 to generate the fracking fluid.

The slurry may then be sent (e.g., via pipes that can transfer the slurry) as a low-pressure slurry 118 to the low-pressure side of manifold (also pump manifold) 104. Manifold 104 may then transfer (e.g., via a set of pipes) the slurry to the pumps 102 for pressurization. Each pump 102 may output, at a setpoint flow rate, a corresponding pump output slurry 114 to the high-pressure side of manifold 104.

Finally, manifold 104 may then output a combined high-pressure slurry 115, at a total pump rate that is the combination of the individual pump rates for pumps 102, to borehole 116.

The control center 112 may include a computer system comprising hardware and software to monitor and control the entire fracturing spread as illustrated in environment 100. By way of example, the total pump rate and corresponding pump rate set points for each pump 102 may be controlled via control center 112. For example, each pump 102 may have a corresponding controller that can adjust the pump rate of pump output slurry 114 outputted by each pump 102. The control center 112 may be communicatively coupled to each controller of each pump 102 such that the pump rates for each pump 102 are configurable by control center 112.

The control center 112 may send (e.g., via a computer system) pump rate setpoints (e.g., barrels per minute) to each of the pumps 102, via their respective controllers, such that the combined pump rate of pumps 102 is a desired target total pump rate.

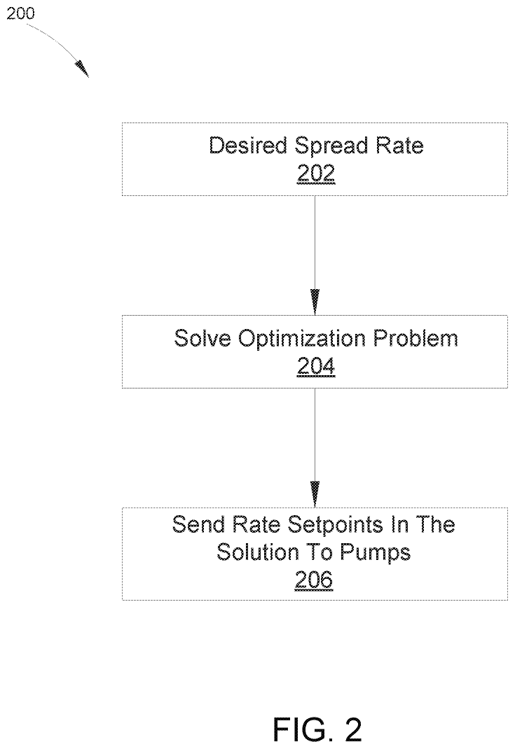

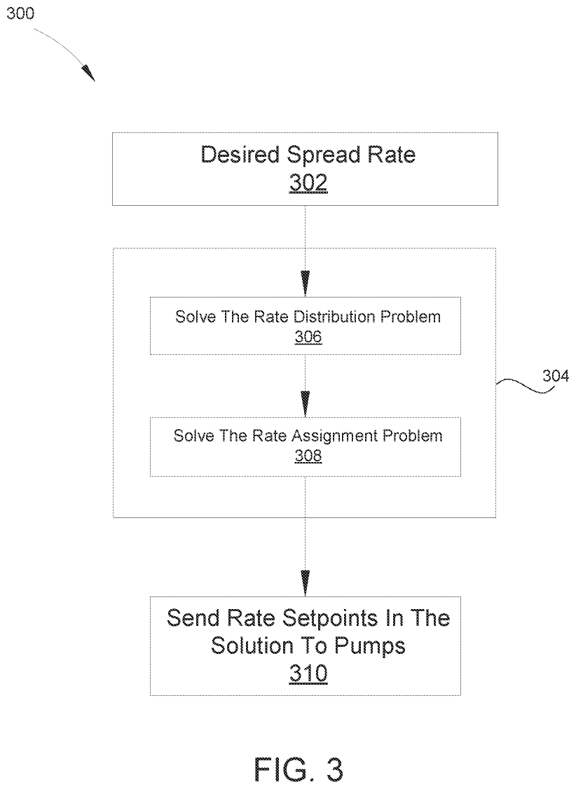

The optimization process of the pump rate set points for pumps 102 of the disclosed technology will be discussed in further detail in FIG. 2 and FIG. 3 below. In some examples, control center 112 may receive a desired or target total pump rate from an external source (e.g., another computer at a remote location).

In some cases, environment 100 can include a maintenance truck 120 or equivalent maintenance setup equipped with tools and parts for the repair and upkeep of the fracturing equipment. For example, maintenance truck 120 may be equipped with tools, parts, and personnel to repair pumps 102 due to wear and tear.

FIG. 2 illustrates an example workflow 200 for optimizing pump rate setpoints, according to some aspects of the disclosed technology. For example, control center 112 as discussed in FIG. 1 may determine respective pump flow rates to send to each pump in a plurality of pumps (e.g., pumps 102) to achieve a desired total pump rate.

In a hydraulic fracturing spread (e.g., spread may include all the equipment used in hydraulic fracturing at the surface including the pumps, blenders, etc.), consider an example scenario with N pumps, where each pump may have M number of different gears.

In this example workflow 200, a desired total pump rate (e.g., flow rate such as barrels per minute, represented as Q₀ in (3) below) as represented by block 202 may be requested (e.g., via control center 112) which may represent the total pump rate or sum of all the pump rates of the plurality of pumps.

In some aspects, an objective function (e.g., obj(q₁, q₂, . . . , q_{N})) may be known a priori, where qᵢ is the rate (e.g., pump rate or pump flow rate) of the i-th pump. As such, the optimization problem may be represented as the mathematical optimization problem (1) below, subject to constraints (2) and (3).

$${min}_{{g}_{i} , {q}_{i}} obj ( {q}_{1} , {q}_{2} , … , {q}_{N} ) \qquad ( 1 )$$

$${Q}_{min , i} ( {g}_{i} ) \leq {q}_{i} \leq {Q}_{max , i} ( {g}_{i} ) \qquad ( 2 )$$

$${\sum }_{i = 1}^{N} {q}_{i} = {Q}_{0} \qquad ( 3 )$$

The mathematical optimization problem (1) can state the objective function should be minimized (e.g., in some cases, (1) may be maximized rather than minimized). For example, the variables (e.g., arguments) can be gᵢ and qᵢ which may represent the selected gear (gᵢ) and rate (qᵢ) for the i-th pump, respectively. The rate qᵢ may be represented as any non-negative real number and the gear gᵢ may be represented as an integer value between 0 and M.

Constraint (2) can represent that for the i-th pump, the selected rate qᵢ is within the minimum and maximum limited of the selected gear gᵢ. For the zeroth gear, gᵢ=0 which can represent the pump being in a neutral gear and Q_{min,i}(0)=Q_{max,i}(0)=0. Constraint (3) can represent that the sum of rates of each pump (e.g., the sum of the pump flow rates for the plurality of pumps in the fracturing spread) can be equal to the requested rate, Q₀.

In some cases, the mathematical optimization problem (1) can be a mixed-integer nonlinear programming (MINLP) problem. The optimization problem (1) may be solved, as represented by block 204, via any solver (e.g., control center 112 or any other computing system with hardware and software to solve the MINLP problem). Next, workflow 200 can continue to block 206 and the rate setpoints in the solution to the optimization problem (1) may be sent to the pumps (e.g., control center 112 can assign pump flow rates to each pump in the plurality of pumps 102).

FIG. 3 illustrates another example workflow 300 for optimizing pump rate setpoints, according to some aspects of the disclosed technology. In the example workflow 300, a desired total pump rate (e.g., flow rate such as barrels per minute, represented as Q₀ in (3) described above with respect to FIG. 2) as represented by block 302 may be requested (e.g., via control center 112) which may represent the total pump rate or sum of all the pump rates of the plurality of pumps.

In some cases, the MINLP (e.g., optimization problem (1)) as described above with respect to FIG. 2 can be computationally expensive (e.g., a computer system may take an extended period of time to solve the problem). In some aspects, the following two assumptions can be made to expedite the time and/or computational resources to solve optimization problem:

First Assumption-All the pumps (e.g., pumps 102) have the same constraints. For example, all the pumps have the same specification (e.g., the same engine, transmission, etc.). The health of the pumps may be relatively similar (e.g., similar amounts of wear and tear). In this assumption, Q_{min,i} and Q_{max,i} in (2) are the same for i=1, . . . , N.

Second Assumption—the objective function obj(q₁, q₂, . . . , q_{N}) is in the form (4) below:

$$obj ( {q}_{1} , {q}_{2} , … , {q}_{N} ) = {\sum }_{i = 1}^{N} f ( {q}_{i} ) \qquad ( 4 )$$

In the second assumption, ƒ(qᵢ) can be the cost of running a pump at rate qᵢ. In the first assumption, since all the pumps (e.g., pumps 102) are the same, the second assumption can be valid since the cost function is the same and is only dependent on the rate.

After taking account of first and second assumptions above, optimization problem (1) can be solved in two steps as described below. In other words, by including the two assumptions described above, the optimization problem represented by block 304 (e.g., 204) can be broken down into steps represented by blocks 306 and 308 for the first and second steps, respectively.

First Step—Determine a set of rates {r₁, r₂, . . . , r_{N}} in the ascending order that minimizes the objective function:

$${min}_{{g}_{i} , {r}_{i}} {\sum }_{i = 1}^{N} f ( {r}_{i} ) \qquad ( 5 )$$

Where (5) is subject to the following constraints:

$${Q}_{min} ( {g}_{i} ) \leq {r}_{i} \leq {Q}_{max} ( {g}_{i} ) \qquad ( 6 )$$

$${\sum }_{i = 1}^{N} {r}_{i} = {Q}_{0} \qquad ( 7 )$$

$${r}_{1} \leq {r}_{2} \leq … \leq {r}_{N} ; {g}_{i} = 0 , 1 , … , M \qquad ( 8 )$$

The above optimization problem may be designated as a rate distribution problem. In some cases, the set of rates may also be determined in descending order instead of ascending order.

Second Step—Assign the rates {r₁, r₂, . . . , r_{N}} to each of the pumps such that each pump may pick a rate only once. The assignment problem may be determined by the following optimization problem:

$$min {\sum }_{i , j ∈ ( N , N )} {w}_{i , j} {x}_{i , j} \qquad ( 9 )$$

Where (9) is subject to the following constraints:

$${\sum }_{i = 1}^{N} {x}_{i , j} = 1 \qquad ( 10 )$$

$${\sum }_{j = 1}^{N} {x}_{i , j} = 1 \qquad ( 11 )$$

where x_{i,j}=0 or 1, i=1, . . . , N, j=1, . . . , N.

In (9) above, w_{i,j} can be the cost of assigning rate rᵢ to pump j and x_{i,j} can be the binary assignment variable where x_{i,j}=1 can mean that rate rᵢ is assigned to pump j while x_{i,j}=0 can mean that rate rᵢ is not assigned to pump j.

Constraint (10) states that each pump must have one rate assigned and Constraint (11) states that each rate must be assigned to one pump.

By way of example, the assignment cost can be w_{i,j}=|q_{curr,j}−rᵢ| which is the difference between the current pump rate and the new pump rate.

In some aspects, in the first step, optimization problem (5) can be solved with pseudo-polynomial time because of the ascending order constraint (8) which shrinks the search space. In the second step, the assignment problem (9) can be solved in polynomial time by well-known methods such as the Hungarian algorithm. Those skilled in the art will appreciate additional methods to solve the assignment problem (9).

In some aspects, constraint (8) may be replaced by a descending order constraint where r₁≥r₂≥ . . . ≥r_{N}.

In some examples, staggering in rates may be designed to avoid resonance. An additional penalty term may be added to the objective function and additional constraints may be added too as represented by the following alternative objective function (12):

$${min}_{{g}_{i} , {r}_{i}} [ {\sum }_{i = 1}^{N} f ( {r}_{i} ) ] + {w}_{stagger} {\sum }_{i = 1}^{N - 1} {z}_{stagger , i} \qquad ( 12 )$$

Where (12) is subject to the following constraints:

$${Q}_{min} ( {g}_{i} ) \leq {r}_{i} \leq {Q}_{max} ( {g}_{i} ) \qquad ( 13 )$$

$${\sum }_{i = 1}^{N} {r}_{i} = {Q}_{0} \qquad ( 14 )$$

$${r}_{1} \leq {r}_{2} \leq … \leq {r}_{N} \qquad ( 15 )$$

$${z}_{s t agger , i} = \{ \begin{matrix}0 , & if {r}_{i + 1} - {r}_{i} \geq Δ Q \\ 1 , & if {r}_{i + 1} - {r}_{i} < Δ Q\end{matrix} \qquad ( 16 )$$

$${g}_{i} = 0 , 1 , … , M$$

As compared to objective function (5) and corresponding constraints (6), (7), (8) the additional constraint (16) can define a new binary variable z_{stagger,i} which is 1 when two adjacent rates are not staggered by at least ΔQ and is 0 if staggering is met. A penalty w_{stagger} can be added to the alternative objective function (12) each time when rate staggering is not met.

In some cases, in order to convert alternative objective function (12) to a standard MINLP problem, constraint (16) needs to be converted to a linear constraint (e.g., using big-M method). Those skilled in the art will appreciate additional methods of converting constraint (16) to a linear constraint.

Next, workflow 300 can continue to block 310 and the rate setpoints in the solution to optimization problem (e.g., based on objective function (5) and corresponding constraints (6), (7), (8) or based on objective function (12) and corresponding constraints (13), (14), (15), (16)) may be sent to the pumps (e.g., control center 112 can assign pump flow rates to each pump in the plurality of pumps 102).

In some examples, if there is more than one type of pump, each pump type may be considered as a group. Assume there are K types of pumps, and each type group has Nₖ pumps, k=1, . . . , K with a cost function fₖ(·), which is the cost for k-th type of pump, k=1, . . . , K. Then objective function (5) becomes (17), with constraints adjusted accordingly:

$${min}_{{g}_{i} , {r}_{i}} {\sum }_{k}^{K} {\sum }_{i = 1}^{{N}_{k}} {f}_{k} ( {r}_{i} ) \qquad ( 17 )$$

In some cases, different types of the cost function ƒ(q) can include maintenance cost, fuel cost, consumable parts cost, or the combination of these.

Instead of minimizing a cost function, the objective is to maximize a reward function. Examples of reward functions may include gas substitution ratio (e.g., if a pump has a dual-fuel engine), diesel savings (e.g., if a pump has a dual-fuel engine), hourly operating profit, or the combination of these reward functions. In the scenario where both rewards and costs exist, maximizing rewards minus costs or minimizing costs minus rewards are two available options.

In some aspects, in the case where the fracking spread is under split-flow operation, if assuming all pumps are the same, the pumps are grouped into two sides, dirty pumps and clean pumps. An additional objective term can represent the split flow ratio and can be added to the objective function. For example, (12) may be alternatively written as below:

$${min}_{{g}_{i} , {r}_{i}} [ {\sum }_{i = 1}^{N} f ( {r}_{i} ) ] + {w}_{stagger} {\sum }_{i = 1}^{N - 1} {z}_{stagger , i} + {w}_{split} \cdot {\sum }_{l ∈ \{ dirty \}} {q}_{l} / {\sum }_{m ∈ \{ clean \}} {q}_{m}$$

Where {dirty} and {clean} represents the indices of dirty and clean side pumps, respectively.

In some embodiments, in the rate assignment problem, w_{i,j} may also include other costs and/or penalties, such as gear shift, turning a pump on, turning a pump off, etc. In some cases, w_{i,j} in the rate assignment problem can be a reward function. For example, a reward is given if there is no adjustment of gear and/or throttle. In these cases, the objective becomes maximization instead of minimization.

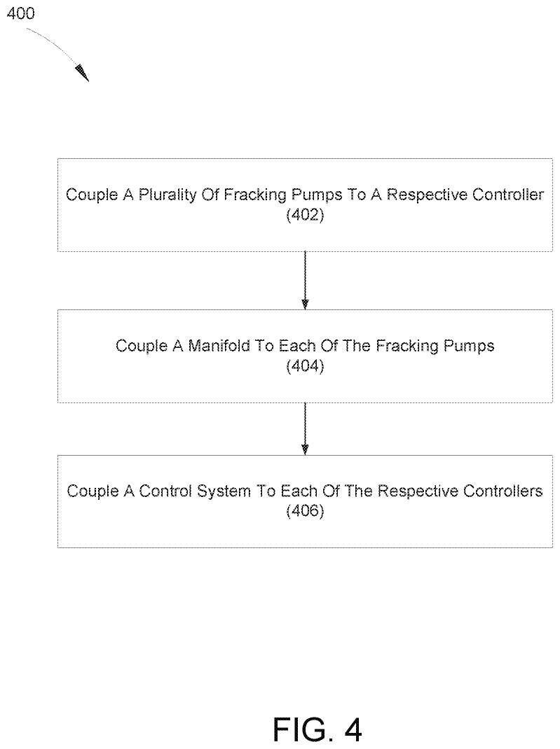

FIG. 4 illustrates an example process 400 for optimizing pump rate setpoints, according to some aspects of the disclosed technology. At step 402, process 400 includes coupling a plurality of fracking pumps to a respective controller. For example, in a fracking spread (e.g., fracking spread 100), hydraulic fracking pumps (e.g., pumps 102) may each have a local controller to adjust the rate and gear to track the rate setpoint. For example, the local controller for each pump can adjust the pump gear and rate (e.g., flow rate or pump rate in barrels per minute) based on the pump rate setpoint received by the pump. In some cases, the local controller may be wirelessly connected or hardwired to the pump to enable communication.

At block 404, process 400 includes coupling a manifold to each of the fracking pumps. Each pump may be connected to a manifold (e.g., manifold 104) via a pipe or other means to transmit slurry from the pump to the manifold. In some cases, a plurality of pumps can all be connected to the same manifold. The manifold may have a low-pressure side capably of receiving low-pressure fracking fluid (e.g., from a blender) and a high-pressure side capable of receiving high-pressure fracking fluid (e.g., from the pumps).

At block 406, process 400 includes coupling a control system to each of the respective controllers. For example, each pump's controller can be connected to a control system (e.g., wired or wireless RF connection) to allow for communication between the control system and controller. The control system can send a pump rate setpoint (e.g., based on the solution to the optimization problem described in FIG. 2 and FIG. 3) to the controller of each pump. When the pump's controller receives the pump rate setpoint from the control system, the controller can adjust the current pump rate of that respective pump (e.g., flow rate of fracking fluid in barrels per minute) to match the pump rate setpoint.

In some aspects, the control system can receive a total pump rate for the manifold. For example, an external user can send a total pump rate value to the control system that indicates the desired total pump rate from all the pump rates combined for all the pumps in a fracking spread. Based on the desired total pump rate (e.g., received by the control system), the control system's computer system and corresponding hardware and software can determine, based on the solution to the optimization problem as discussed above in FIG. 2 and FIG. 3, the pump rate setpoint for each pump in the fracking spread (e.g., to achieve the total pump rate).

In some aspects, the solution to the optimization problem can be based on minimizing the operating costs associating with operating all the pumps in the fracking spread. For example, the solution to the optimization problem may determine pump rates for each of the pumps in the spread to minimize the amount of wear and tear and potential costs incurred. In another example, the optimization problem may be based on maximizing a reward function, such as a scenario with using as much gas as possible for the pumps instead of Diesel fuel.

In some examples, each pump in the fracking spread may have a unique pump rate to avoid issues including, but not limited to, resonance. Those skilled in the art will appreciate additional reasons why each pump in a fracking spread may ideally have different pump rates.

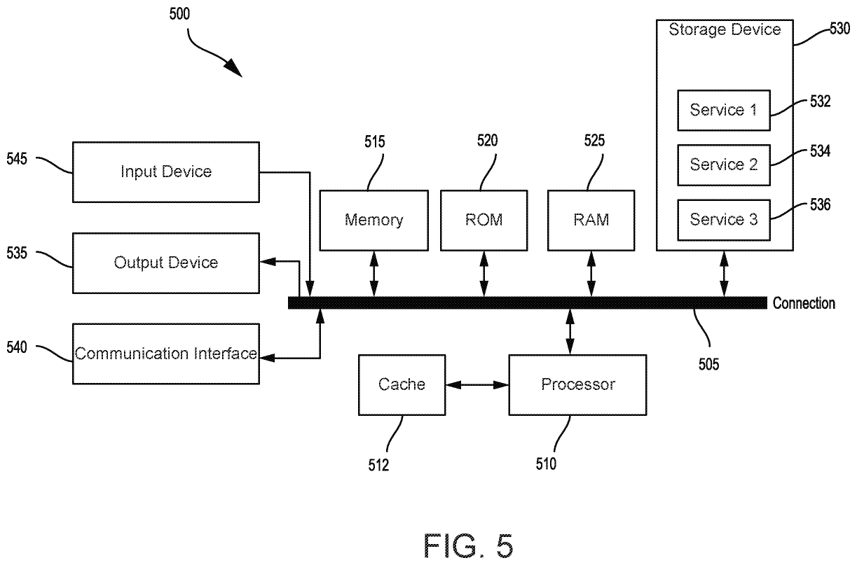

FIG. 5 illustrates an example processor-based system with which some aspects of the subject technology can be implemented. For example, processor-based system 500 can be any computing device making up, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 500 includes at least one processing unit (Central Processing Unit (CPU) or processor) 510 and connection 505 that couples various system components including system memory 515, such as Read-Only Memory (ROM) 520 and Random-Access Memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a Universal Serial Bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a Radio-Frequency Identification (RFID) wireless signal transfer, Near-Field Communications (NFC) wireless signal transfer, Dedicated Short Range Communication (DSRC) wireless signal transfer, 802.11 Wi-Fi® wireless signal transfer, Wireless Local Area Network (WLAN) signal transfer, Visible Light Communication (VLC) signal transfer, Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a Compact Disc (CD) Read Only Memory (CD-ROM) optical disc, a rewritable CD optical disc, a Digital Video Disk (DVD) optical disc, a Blu-ray Disc (BD) optical disc, a holographic optical disk, another optical medium, a Secure Digital (SD) card, a micro SD (microSD) card, a Memory Stick® card, a smartcard chip, a EMV chip, a Subscriber Identity Module (SIM) card, a mini/micro/nano/pico SIM card, another Integrated Circuit (IC) chip/card, Random-Access Memory (RAM), Atatic RAM (SRAM), Dynamic RAM (DRAM), Read-Only Memory (ROM), Programmable ROM (PROM), Erasable PROM (EPROM), Electrically Erasable PROM (EEPROM), flash EPROM (FLASHEPROM), cache memory (L1/L2/L3/L4/L5/L #), Resistive RAM (RRAM/ReRAM), Phase Change Memory (PCM), Spin Transfer Torque RAM (STT-RAM), another memory chip or cartridge, and/or a combination thereof.

Storage device 530 can include software services, servers, services, etc., that when the code that defines such software is executed by the processor 510, it causes the system 500 to perform a function. In some embodiments, a hardware service that performs a particular function can include the software component stored in a computer-readable medium in connection with the necessary hardware components, such as processor 510, connection 505, output device 535, etc., to carry out the function.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network Personal Computers (PCs), minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

### Selected Examples

Illustrative examples of the disclosure include:
Aspect 1. A fracking spread, comprising: a plurality of fracking pumps, wherein each of the fracking pumps are communicatively coupled to a respective controller; a manifold fluidically coupled to each of the fracking pumps; and a control system coupled to each of the respective controllers, wherein the control system is configured to perform operations for: receiving a total pump rate for the manifold; determining a pump rate setpoint for each of the plurality of fracking pumps, wherein the pump rate setpoint for each of the plurality of fracking pumps is based on a solution to an optimization problem and wherein the optimization problem is based on minimizing a cost function associated with the plurality of fracking pumps; and transmitting the pump rate setpoint for each of the plurality of fracking pumps to each of the respective controllers.
Aspect 2. The fracking spread of Aspect 1, wherein the total pump rate for the manifold is based on the pump rate setpoint for each of the plurality of fracking pumps.
Aspect 3. The fracking spread of any of Aspects 1-2, wherein the pump rate setpoint for each of the plurality of fracking pumps is a unique value.
Aspect 4. The fracking spread of any of Aspects 1-3, wherein the cost function represents a cost of operating the plurality of fracking pumps, wherein each of the fracking pumps are operating at a corresponding pump rate setpoint.
Aspect 5. The fracking spread of any of Aspects 1-4, wherein a flow rate for each of the plurality of fracking pumps is adjusted by the respective controller.
Aspect 6. The fracking spread of Aspect 5, wherein the flow rate for each of the plurality of fracking pumps is based on the pump rate setpoint received by the respective controller.
Aspect 7. The fracking spread of any of Aspects 1-6, wherein the pump rate setpoint is within a range of values based on a gear for an engine mechanically coupled to the associated pump.
Aspect 8. A method comprising: coupling a plurality of fracking pumps to a respective controller; coupling a manifold to each of the fracking pumps; and coupling a control system to each of the respective controllers, wherein the control system is configured to perform operations for: receiving a total pump rate for the manifold; determining a pump rate setpoint for each of the plurality of fracking pumps, wherein the pump rate setpoint for each of the plurality of fracking pumps is based on a solution to an optimization problem and wherein the optimization problem is based on minimizing a cost function associated with the plurality of fracking pumps; and transmitting the pump rate setpoint for each of the plurality of fracking pumps to each of the respective controllers.
Aspect 9. The method of Aspect 8, wherein the total pump rate for the manifold is based on the pump rate setpoint for each of the plurality of fracking pumps.
Aspect 10. The method of any of Aspects 8-9, wherein the pump rate setpoint for each of the plurality of fracking pumps is a unique value.
Aspect 11. The method of any of Aspects 8-10, wherein the cost function represents a cost of operating the plurality of fracking pumps, wherein each of the fracking pumps are operating at a corresponding pump rate setpoint.
Aspect 12. The method of any of Aspects 8-11, wherein a flow rate for each of the plurality of fracking pumps is adjusted by the respective controller.
Aspect 13. The method of Aspect 12, wherein the flow rate for each of the plurality of fracking pumps is based on the pump rate setpoint received by the respective controller.
Aspect 14. The method of any of Aspects 8-13, wherein the pump rate setpoint is within a range of values based on a gear for an engine mechanically coupled to the associated pump.
Aspect 15. A non-transitory computer-readable storage medium comprising at least one instruction for causing a computer or processor to: receive a total pump rate for a manifold, wherein the manifold is coupled to each of a plurality of fracking pumps and each of the plurality of fracking pumps is associated with a respective controller; determine a pump rate setpoint for each of the plurality of fracking pumps, wherein the pump rate setpoint for each of the plurality of fracking pumps is based on a solution to an optimization problem and wherein the optimization problem is based on minimizing a cost function associated with the plurality of fracking pumps; and transmit the pump rate setpoint for each of the plurality of fracking pumps to each of the respective controllers.
Aspect 16. The non-transitory computer-readable storage medium of Aspect 15, wherein the total pump rate for the manifold is based on the pump rate setpoint for each of the plurality of fracking pumps.
Aspect 17. The non-transitory computer-readable storage medium of any of Aspects 15-16, wherein the pump rate setpoint for each of the plurality of fracking pumps is a unique value.
Aspect 18. The non-transitory computer-readable storage medium of any of Aspects 15-17, wherein the cost function represents a cost of operating the plurality of fracking pumps, wherein each of the fracking pumps are operating at a corresponding pump rate setpoint.
Aspect 19. The non-transitory computer-readable storage medium of any of Aspects 15-18, wherein a flow rate for each of the plurality of fracking pumps is adjusted by the respective controller.
Aspect 20. The non-transitory computer-readable storage medium of any of Aspects 15-19, wherein the flow rate for each of the plurality of fracking pumps is based on the pump rate setpoint received by the respective controller.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

What is claimed is:

1. A fracking spread, comprising:
a plurality of fracking pumps, wherein each of the fracking pumps are communicatively coupled to a respective controller;
a manifold fluidically coupled to each of the fracking pumps; and
a control system coupled to each of the respective controllers, wherein the control system is configured to perform operations for:
receiving a total pump rate for the manifold;
determining a pump rate setpoint for each of the plurality of fracking pumps, wherein the pump rate setpoint for each of the plurality of fracking pumps is based on a solution to an optimization problem and wherein the optimization problem is based on minimizing a cost function associated with the plurality of fracking pumps; and
transmitting the pump rate setpoint for each of the plurality of fracking pumps to each of the respective controllers.

2. The fracking spread of claim 1, wherein the total pump rate for the manifold is based on the pump rate setpoint for each of the plurality of fracking pumps.

3. The fracking spread of claim 1, wherein the pump rate setpoint for each of the plurality of fracking pumps is a unique value.

4. The fracking spread of claim 1, wherein the cost function represents a cost of operating the plurality of fracking pumps, wherein each of the fracking pumps are operating at a corresponding pump rate setpoint.

5. The fracking spread of claim 1, wherein a flow rate for each of the plurality of fracking pumps is adjusted by the respective controller.

6. The fracking spread of claim 5, wherein the flow rate for each of the plurality of fracking pumps is based on the pump rate setpoint received by the respective controller.

7. The fracking spread of claim 1, wherein the pump rate setpoint is within a range of values based on a gear for an engine mechanically coupled to the associated pump.

8. A method comprising:
coupling a plurality of fracking pumps to a respective controller;
coupling a manifold to each of the fracking pumps; and
coupling a control system to each of the respective controllers, wherein the control system is configured to perform operations for:
receiving a total pump rate for the manifold;
determining a pump rate setpoint for each of the plurality of fracking pumps, wherein the pump rate setpoint for each of the plurality of fracking pumps is based on a solution to an optimization problem and wherein the optimization problem is based on minimizing a cost function associated with the plurality of fracking pumps; and
transmitting the pump rate setpoint for each of the plurality of fracking pumps to each of the respective controllers.

9. The method of claim 8, wherein the total pump rate for the manifold is based on the pump rate setpoint for each of the plurality of fracking pumps.

10. The method of claim 8, wherein the pump rate setpoint for each of the plurality of fracking pumps is a unique value.

11. The method of claim 8, wherein the cost function represents a cost of operating the plurality of fracking pumps, wherein each of the fracking pumps are operating at a corresponding pump rate setpoint.

12. The method of claim 8, wherein a flow rate for each of the plurality of fracking pumps is adjusted by the respective controller.

13. The method of claim 12, wherein the flow rate for each of the plurality of fracking pumps is based on the pump rate setpoint received by the respective controller.

14. The method of claim 8, wherein the pump rate setpoint is within a range of values based on a gear for an engine mechanically coupled to the associated pump.

15. A non-transitory computer-readable storage medium comprising at least one instruction for causing a computer or processor to:
receive a total pump rate for a manifold, wherein the manifold is coupled to each of a plurality of fracking pumps and each of the plurality of fracking pumps is associated with a respective controller;
determine a pump rate setpoint for each of the plurality of fracking pumps, wherein the pump rate setpoint for each of the plurality of fracking pumps is based on a solution to an optimization problem and wherein the optimization problem is based on minimizing a cost function associated with the plurality of fracking pumps; and
transmit the pump rate setpoint for each of the plurality of fracking pumps to each of the respective controllers.

16. The non-transitory computer-readable storage medium of claim 15, wherein the total pump rate for the manifold is based on the pump rate setpoint for each of the plurality of fracking pumps.

17. The non-transitory computer-readable storage medium of claim 15, wherein the pump rate setpoint for each of the plurality of fracking pumps is a unique value.

18. The non-transitory computer-readable storage medium of claim 15, wherein the cost function represents a cost of operating the plurality of fracking pumps, wherein each of the fracking pumps are operating at a corresponding pump rate setpoint.

19. The non-transitory computer-readable storage medium of claim 15, wherein a flow rate for each of the plurality of fracking pumps is adjusted by the respective controller.

20. The non-transitory computer-readable storage medium of claim 19, wherein the flow rate for each of the plurality of fracking pumps is based on the pump rate setpoint received by the respective controller.
